(19) United States
(12) Patent Application Publication
(10) Pub. No.: US 2009/0023388 A1
(43) Pub. Date: Jan. 22, 2009

(54) Wireless transceiver and microphone based communications system

(75) Inventor: Ming-Cheng Chung, Taichung (TW)

Correspondence Address: BACON & THOMAS, PLLC, 625 SLATERS LANE, FOURTH FLOOR, ALEXANDRIA, VA, 22314-1176, US

(73) Assignee: JTS PROFESSIONAL CO., LTD., Taichung (TW)

(21) Appl. No.: 11/826,786

(22) Filed: Jul. 18, 2007

(51) Int. Cl. H04B 7/00; H04M 1/00

(52) U.S. Cl. 455/41.2; 455/556.2

(57) ABSTRACT

In one embodiment a communications system includes at least one wireless microphone having a communications modules and a wireless transceiver also having a communications modules. In one operation the transceiver is adapted to send data to each microphone after setting a common operating frequency and ID. A PC having a wireless communications module is provided in another embodiment. The PC is adapted to activate the transceiver to send data to each microphone through its communications module. Each communications modules is complied with IEEE 802.15.4 standard.

### BACKGROUND OF THE INVENTION

1. Field of Invention

The invention relates to wireless communications system and more particularly to such a system comprising at least one wireless microphone, and a wireless transceiver which is adapted to send data to each microphone after setting a common operating frequency and ID.

2. Description of Related Art

Typically, electrical devices including microphones and stereos are connected to wall outlets in a room of a KTV center. One drawback is that wires may get tangled.

Still typically, as an improvement of the above arrangement, the microphones are replaced with wireless ones. Also, one or more controllers are provided in which each controller is adapted to control two wireless microphones. Thus, for example, three controllers are required to control six wireless microphones. This inevitably will increase operating cost greatly. Thus, the need for improvement still exists.

### SUMMARY OF THE INVENTION

It is therefore one object of the invention to provide a communications system comprising at least one wireless microphone and a wireless transceiver. In one operation, the transceiver is adapted to send data to each microphone after setting a common operating frequency and ID. In another operation, the transceiver is adapted to receive data from the microphone(s) which has(have) set a common operating frequency and ID therewith.

The above and other objects, features and advantages of the invention will become apparent from the following detailed description taken with the accompanying drawings.

### BRIEF DESCRIPTION OF THE DRAWINGS

FIG. 1 is a block diagram of a first preferred embodiment of communications system according to the invention; and

FIG. 2 is a block diagram of a second preferred embodiment of communications system according to the invention.

### DETAILED DESCRIPTION OF THE INVENTION

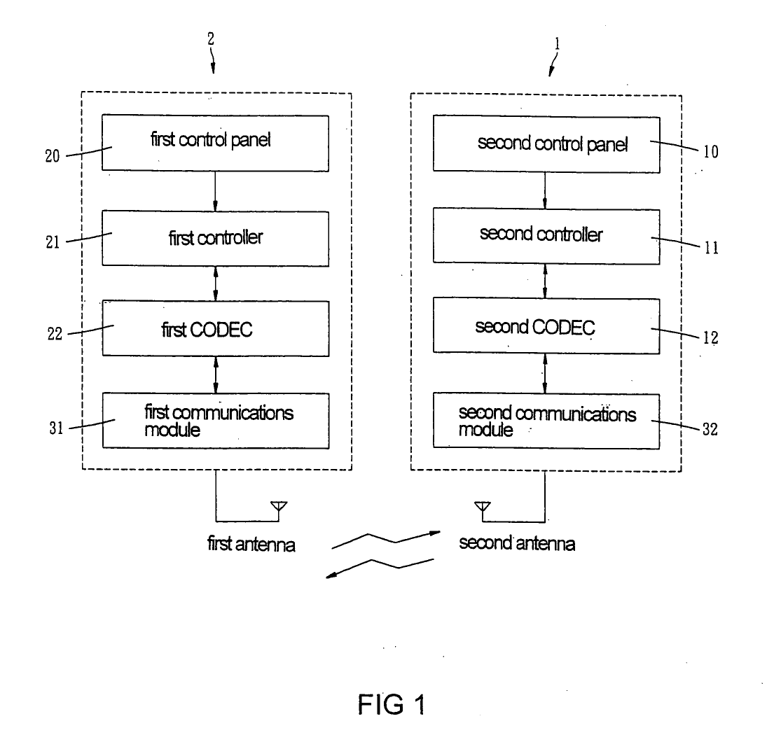

Referring to FIG. 1, a communications system in accordance with a first preferred embodiment of the invention is shown. The system comprises a wireless microphone 1 and a wireless transceiver 2. Note that the system can comprises a plurality of wireless microphones in other embodiments. Each component is discussed in detailed below.

The transceiver 2 comprises a first control panel 20, a first controller 21 on the first control panel 20 for setting a channel, transmission power, and a transmission range, a first codec 22 in the first control panel 20, a first communications module 31 in the first control panel 20, and a first antenna (not numbered) extending out of the housing of the transceiver 2.

Likewise, the microphone 1 comprises a second control panel 10, a second controller 11 on the second control panel 10 for setting a channel, transmission power, and a transmission range, a second codec 12 in the second control panel 10, a second communications module 32 in the second control panel 10; and a second antenna (not numbered) extending out of the housing of the microphone 1.

Each of the communications modules 31, 32 includes circuitry and is complied with IEEE 802.15.4 standard. Also, the first communications module 31 in the transceiver 2 is adapted to send data at a rate of lower than 200 kbit/s over WPAN (wireless personal area network).

Moreover, the first controller 21 can set an operating frequency and an identification (ID) of each of the transceiver 2 and the microphone 1 such that in one operation data can be sent from the transceiver 2 to the microphone 1 as detailed later.

For example, in an exemplary operation, data is first encoded with an ID by the first codec 22 in which the ID is set by the first controller 21. Next, the encoded data is sent to the first communications module 31. Next, the first communications module 31 sends the data to the first antenna of the transceiver 2 which in turn sends radio waves containing the data to the second antenna of the microphone 1 for receiving.

The received data is then sent to the second communications module 32 of the microphone 1. The second communications module 32 of the microphone 1 in turn sends same to the second codec 12 for decoding. Next, the decoded data is sent to the second controller 11 for processing. In detail, the second controller 11 determines whether ID of the received data to be valid or not by comparing the ID of the received data with an ID of the second controller 11 in which the ID of the second controller 11 is also set by the transceiver 2. The second controller 11 then processes the received data accordingly if the comparison result is true.

It is noted that a single transceiver 2 can control a plurality of microphones 1 wirelessly without causing interference between the microphones 1. Thus, operating cost is great reduced.

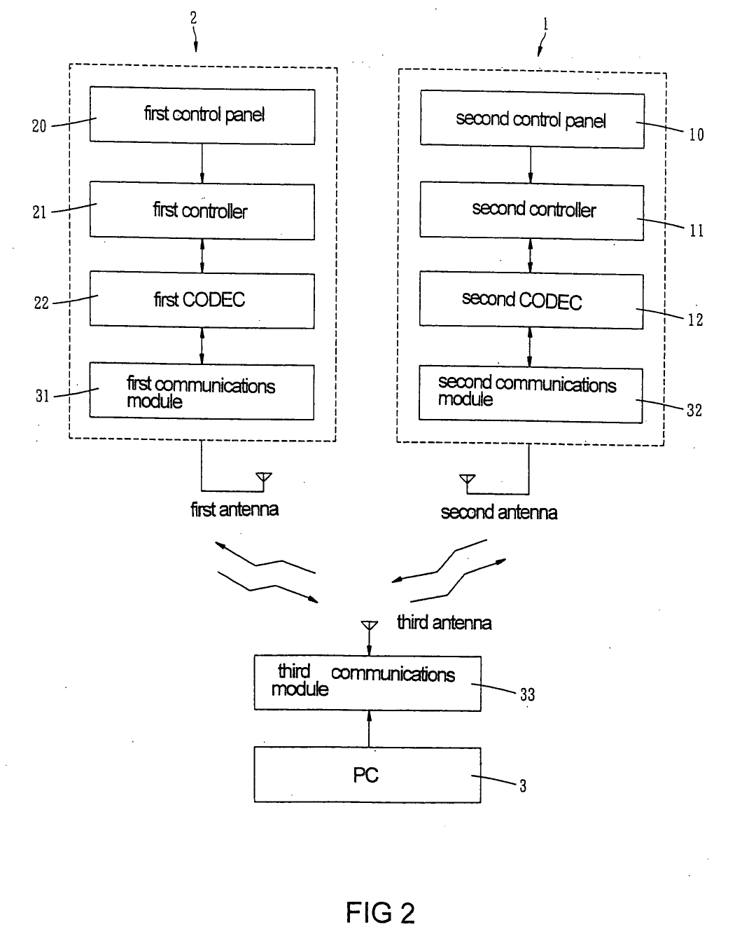

Referring to FIG. 2, a communications system in accordance with a second preferred embodiment of the invention is shown. The characteristics of the second preferred embodiment are detailed below. A PC 3 having a third communications module 33 is provided. Also, the third communications module 33 is equipped with a third antenna (not numbered). The third communications module 33 is also complied with IEEE 802.15.4 standard. In one operation, a user can run software in the PC 3 to operate the third communications module 33 which in turn activates the data sending mechanism of the transceiver 2 as described above. Moreover, a WPAN can be established by wirelessly connecting the wireless transceiver 2, one or more wireless microphones 1, the PC 3 together.

Alternatively, the PC 3 can be replaced by a PDA (Personal Digital Assistant) in the other embodiments.

Each embodiment can prevent two microphones from operating in the same operating frequency. Otherwise, interference can occur.

In addition, a user can activate either the first controller 21 of the transceiver 2 or the PC 3 to remotely locate and eliminate the source of trouble occurred in any microphone 1. Further, either the first controller 21 of the transceiver 2 or the PC 3 can reset the operating frequencies of the microphones 1 for maintaining quality of the microphones.

While the invention herein disclosed has been described by means of specific embodiments, numerous modifications and variations could be made thereto by those skilled in the art without departing from the scope and spirit of the invention set forth in the claims.

What is claimed is:

1. A communications system comprising:
at least one wireless microphone each including a first control panel, a first controller on the first control panel, a first codec (coder-decoder) in the first control panel, a first communications module in the first control panel, and a first antenna; and
a wireless transceiver including a second control panel, a second controller on the second control panel for setting an operating frequency and an ID (identification) thereof and an operating frequency and an ID of each microphone, a second codec in the second control panel, a second communications module in the second control panel, and a second antenna,
wherein in a communications operation in the transceiver data is encoded with an ID by the second codec, the encoded data is sent to the second communications module, the second communications module sends the encoded data to the second antenna, and the second antenna sends radio waves containing the encoded data, in each microphone the first antenna receives and sends the encoded data to the first communications module, the first communications module sends the encoded data to the first codec for decoding, and the decoded data is sent to the first controller, and the first controller is adapted to determine whether the ID of the decoded data is valid or not by comparing the ID of the decoded data with an ID of the microphone.

2. The communications system of claim 1, wherein each of the first and the second communications modules is complied with IEEE 802.15.4 standard.

3. The communications system of claim 1, further comprising a personal computer (PC) including a third communications module and a third antenna, and wherein the PC is adapted to activate the transceiver to send data to each microphone through the third communications module.

4. The communications system of claim 3, wherein the third communications modules is complied with IEEE 802.15.4 standard.

5. The communications system of claim 1, further comprising a personal digital assistant (PDA) including a third communications module and a third antenna, and wherein the PDA is adapted to activate the transceiver to send data to each microphone through the third communications module.

6. The communications system of claim 5, wherein the third communications modules is complied with IEEE 802.15.4 standard.
